(19) United States
(12) Patent Application Publication
(10) Pub. No.: US 2024/0251222 A1
(43) Pub. Date: Jul. 25, 2024

(54) LOCAL AREA INTEGRATED DRONE, AIRCRAFT, VEHICLE, AND ASSET MANAGEMENT SYSTEM

(71) Applicant: George Mason University, Fairfax, VA (US)

(72) Inventors: Lance C. Sherry, Fairfax, VA (US); Charlie C. Wang, Aldie, VA (US)

(21) Appl. No.: 18/482,686

(22) Filed: Oct. 6, 2023

Related U.S. Application Data
(60) Provisional application No. 63/413,735, filed on Oct. 6, 2022.

(51) Int. Cl. H04W 4/029; G08G 5/00; H04W 60/00

(52) U.S. Cl. CPC H04W 4/029; G08G 5/0069; H04W 60/00

(57) ABSTRACT

Methods, systems, and apparatuses are described for local area integrated drone, aircraft, vehicles, and asset management. A computing device may receive data from drones, aircrafts, vehicles, and assets, and may perform tracking, registration, planning, deconfliction, and safety monitoring for the local area integrated drone, aircraft, vehicles, and asset management.

### CROSS-REFERENCE TO RELATED APPLICATIONS

This application claims priority to U.S. Provisional Application No. 63/413,735, filed Oct. 6, 2022, the entirety of which is incorporated into this application by reference.

### BACKGROUND

Campuses, such as military bases, airports and industrial parks, include multiple infrastructure and agricultural facilities such as cell phone towers, power generation stations, water and sewage treatment plants, railroad stations and railroad tracks, marinas and waterways. Drones, also known as Small Unmanned Air Systems (sUAS), provide significant efficiency and productivity improvements for infrastructure inspections, aerial surveillance and reconnaissance, and aerial photography and surveying. Campus owners, operators, and facility managers would like to facilitate the use of drones but will need to coordinate and track drone operations along with all other dynamic assets such as aircraft, ground vehicles (e.g. security, fuel trucks, baggage, etc.), and portable assets (e.g. construction equipment, etc.) at the campus.

### SUMMARY

It is understood that both the following general description and the following detailed description are exemplary and explanatory only and are not restrictive.

Methods, systems, and apparatuses are described for local area integrated drone, aircraft, vehicles, and asset management. For example, a computing device may receive, from a plurality of devices, a plurality of data. The plurality of devices may comprise one or more unmanned aerial vehicles (UAVs), one or more ground vehicles, and one or more assets. Each of the plurality of data may comprise location information, system information, and operation information associated with each of the plurality of devices. The computing device may determine an operation boundary associated with the each of the plurality of devices. The computing device may determine, based on the plurality of data and based on the operation boundary associated with each of the plurality of devices, one or more hazards for at least one of the plurality of devices. The one or more hazards may comprise at least one of a conflict, an out-of-bounds location, a low battery status, a low fuel status, or an anomalous operation. The computing device may provide, based on the location information associated with each of the plurality of devices, tracking information of each of the plurality of devices with the one or more hazards associated with at least one of the plurality of devices.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of the present description serve to explain the principles of the methods and systems described herein. To easily identify the discussion of any particular element or act, the most significant digit or digits in a reference number may refer to the figure number in which that element is first introduced.

FIG. 1 shows an example communication system;

FIG. 2 shows an example diagram;

FIG. 3 shows an example method;

FIG. 4 shows an example method;

FIG. 5 shows an example method; and

FIG. 6 shows an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, a computer program product on a computer-readable storage medium (e.g., non-transitory) having processor-executable instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These processor-executable instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These processor-executable instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the terms “user,” or “subject,” may indicate a person who uses an electronic device or a device (e.g., an artificial intelligence electronic device) that uses an electronic device.

Campuses may have multiple tenants with multiple transportation, energy, water, and agricultural infrastructure and facilities. Examples of campuses may include, but are not limited to, small and medium airports, industrial parks, military bases, cell phone towers, power generation stations, water and sewage treatment plants, railroad stations, railroad tracks, marinas and waterways. Each of these facilities and infrastructure may use drones for aerial inspections, surveying, and surveillance. Specifically, drones, known as Small Unmanned Air Systems (sUAS), may provide significant efficiency and productivity improvements for infrastructure inspections, aerial surveillance and reconnaissance, and aerial photography and surveying. Thus, the use of drones at campuses may significantly improve productivity, efficiency and safety at the campuses having multiple tenants with multiple transportation, energy, water, and agricultural infrastructure and facilities.

The facilities and infrastructure described above may also use ground-based vehicles (e.g., maintenance vehicles, security vehicles, construction vehicles, etc.) and fixed/portable assets (e.g., generators, signage, lighting, etc.). Tenants on the campus may improve productivity and increase safety by using drones for inspection and surveillance of their enterprises. Thus, campus owners, operators, and facility managers may need to coordinate and track drone operations by independent facility departments or tenants along with all the ground-vehicles and assets at the campus.

For example, an airport manager may need detailed information of planned and current simultaneous operations at the campus. The detailed information of planned and current simultaneous operations may assist the airport manager to deconflict drone operations and drone-ground operations, and keep track of drone, ground-based vehicles (e.g., security vehicles, fuel trucks, baggage vehicles, etc.) and portable/fixed assets (e.g., construction equipment, signage, etc.) involved in the operations. The detailed operation information may also help the airport manager identify hotspots and quickly address marginally safe operations.

Campus tenants may use drones for inspections and surveillance to reduce costs and improve safety (e.g., manual inspection of smokestacks). Campus managers have potentially conflicting objectives of enabling their tenants to maximize their operations, yet minimize the risk of accident (of any type), but especially through the interaction of tenant operations.

Campus managers may be beholden to the campus owners such as municipalities or airport authorities for revenue generation. Indirectly these authorities may be staffed by elected officials whose constituents want the best of both worlds: low cost, efficient, secure, and safe transportation access, without noise, congestion, and environmental hazards. Campus managers may need to meet local, State, and Federal regulations and support local law enforcement. Campus managers may also need to manage insurance costs that are determined by the perceived risks.

With regard to drone operations, drone operators, either employed by tenants or outsourced by the tenants, may need to comply with Federal regulations regarding vehicle and vehicle operations. They need to remain compliant with procedures for airspace operations including airspace Air navigation Service Provider (ANSP) Universal Traffic Management (UTM) systems, such as the Low Altitude Authorization and Notification Capability (LAANC).

Recent changes in drone standards require drones to be equipped with wireless transmit/receive units to receive control signals and transmit their location and other information with a specified communications protocol. Ground-based vehicles (e.g., construction vehicles, security vehicles, maintenance vehicles, firefighting vehicles, etc.) and portable/fixed assets (e.g., portable signage, construction generators, portable lights, etc.) may also be equipped with wireless transmit/receive units to communicate with the drones. Thus, drones, ground-based vehicles, and portable/fixed assets can be synchronized with these standard communications. With these recent changes, an enterprise-wide management system (e.g., Local Area Integrated Drone, Aircraft, Vehicle, and Asset Management System (LAIDAVAMS)) may improve productivity, efficiency and safety of using drones with ground-based vehicles and fixed/portable assets to the overall enterprise.

Methods, apparatuses, and systems (e.g., LAIDAVAMS) described herein may be used by campus property owners and facility managers to coordinate multiple simultaneous, safe drone and ground operations. In some cases, drone operations may be in proximity to manned flight or other and ground operations. In addition, to drone operations, the methods, apparatuses, and systems described herein may also be used to track campus surface vehicles or ground-based vehicles (e.g., firefighting vehicles, law enforcement vehicles, fuel trucks, maintenance vehicles, etc.) as well as portable/fixed assets (e.g., portable signage, construction generators, portable lights, etc.).

The methods, apparatuses, and systems described herein may include one or more drones, one or more aircrafts, one or more ground-based vehicles and one or more portable/fixed assets. Each of the drones, aircrafts, ground-based vehicles, and portable/fixed assets may be equipped with wireless transmit/receive units and may communicate each other or with a network of ground-based receiver gateways. The methods, apparatuses, and systems described herein may also include data processing and storage, data analysis, visualization, and report generation. In many cases, such as campuses on private property, it may not be feasible or appropriate for a government Air Navigation Service Provider (ANSP) to install and operate the ground-based receiver gateways for the surveillance system. When an ANSP provides surveillance infrastructure, it may have a ground-based receiver gateway independent of the ANSP surveillance system. It may also integrate two or more transmitter/receiver surveillance systems to reduce costs.

Similarly, airports may monitor and improve airport operations by installing and operating surface tracking surveillance systems alongside air traffic control surveillance. The methods, apparatuses, and systems described herein may be designed to operate alongside government air traffic systems such as Universal Traffic Management (UTM) and provide the campus facility manager or the airport operator detailed operational information.

The methods, apparatuses, and systems described herein may interface with government airspace ANSP UTM systems, such as the Low Altitude Authorization and Notification Capability (LAANC). The methods, apparatuses, and systems described herein may provide ground-based detect-and-avoid for drones, ground-based vehicles and portable/fixed assets, as well access to secure areas.

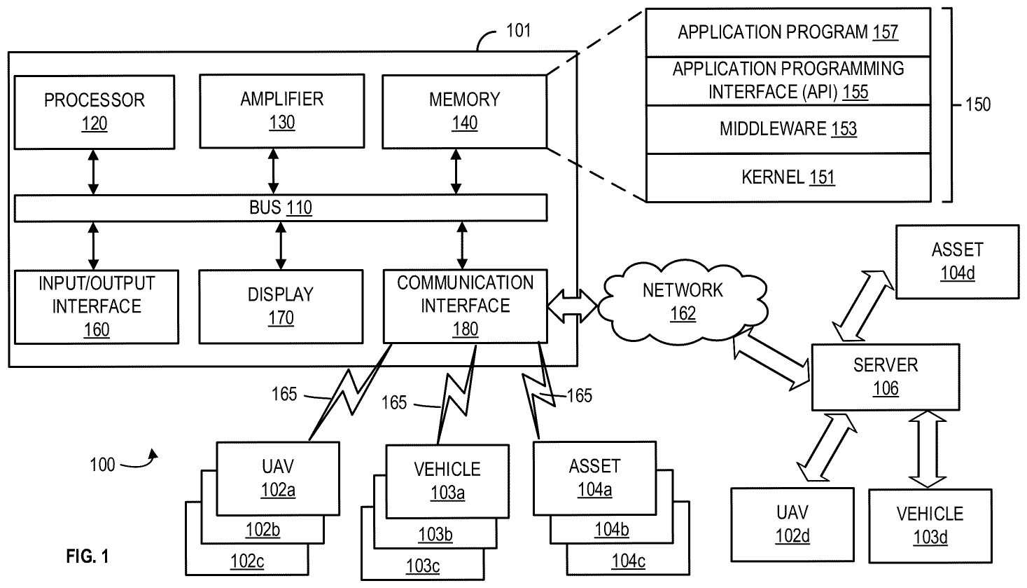

FIG. 1 shows an exemplary communication system 100, where the methods, apparatuses, and systems described herein may be implemented according to various embodiments. Referring to FIG. 1, a computing device 101 in a communication system 100 is disclosed according to various exemplary embodiments. The computing device 101 may include a bus 110, a processor 120, an amplifier 130, a memory 140, an input/output interface 160, a display 170, and a communication interface 180. In a certain exemplary embodiment, the computing device 101 may omit at least one of the aforementioned constitutional elements or may additionally include other constitutional elements. The computing device 101 may comprise a microcomputer, a miniature computer, a single board computer, a microcontroller, or a circuit board. In an embodiment, the computing device 101 may be, for example, a server, a mobile phone, a smart phone, a tablet computer, a laptop, a desktop computer, and the like.

The computing device 101 may be configured to process the signals or data received from other device such as UAVs (or drones) 102a-d, vehicles 103a-d, assets 104a-d, and/or a server 106. The computing device 101 may receive the signals or data using a wireless connection or a wired connection. For example, the computing device 101 may receive data from the UAVs (or drones) 102a-d, the vehicles 103a-d, and/or the assets 104a-d. In an embodiment, the computing device 101 may forward the control signals or data to the UAVs (or drones) 102a-c, the vehicles 103a-c, the assets 104a-c and/or the server 106 for further processing. The computing device 101 may forward the control signals or data to the UAV (or drone) 102d, the vehicle 103d, and/or the asset 104d via the server 106. The UAVs (or drones) 102a-d, the vehicles 103a-d, and/or the assets 104a-d may process the control signals or data and perform operations as instructed by the computing device 101.

The bus 110 may include a circuit for connecting the aforementioned constitutional elements 110 to 180 to each other and for delivering communication (e.g., a control message and/or data) between the aforementioned constitutional elements. For instance, the bus 110 may be designed to send the signals or sensor data from the processor 120 to the communication interface 180 in order to further transmit the signals or sensor data to an external device such as the electronic device 102 and/or a server 106.

The processor 120 may include one or more of a Microcontroller Unit (MCU), a Central Processing Unit (CPU), an Application Processor (AP), and a Communication Processor (CP). The processor 120 may control, for example, at least one of the other constitutional elements of the computing device 101 and/or may execute an arithmetic operation or data processing for communication. The processing (or controlling) operation of the processor 120 according to various embodiments is described in detail with reference to the following drawings.

In an embodiment, the processor 120 may receive a plurality of data from a plurality of devices such as the UAVs 102a-d, the vehicles 103a-d, and/or the assets 104a-d. The processor 120 may receive the plurality of data via the communication interface 180 directly from the UAVs 102a-d, the vehicles 103a-d, and/or the assets 104a-d or from the server 106 via the network 162. The vehicles 103a-d may be ground-based vehicles (e.g., ground-based vehicles 203a-c). The assets may be portable assets (e.g., portable assets 204a-c) or fixed assets (e.g., fixed assets 205a-c). Each of the plurality of data may comprise location information, system information, and operation information associated with each of the plurality of devices. The location information may comprise geographical positions such as GPS coordinates, latitude and longitude coordinates, altitude providing the height or elevation above sea level, speed, direction, geofenced area or boundaries associated with operations, addresses, location names, and/or locations associated with operators.

The system information may comprise timestamp records with the date and time when location data were captured, an identity or a tag for each tracked device, device or sensor information, environmental conditions (e.g., temperature, humidity, air quality, etc.), a battery status, a power status, a fuel status, and/or data source. The operation information may comprise locations of operations, altitudes of operations, operation schedules, operation statuses, and/or operator information.

The processor 120 may determine the operation boundary associated with each of the plurality of devices. The processor 120 may determine the operation boundary based on a type of operation, a schedule of the operation, a location of the operation and/or the like. The processor 120 may determine one or more hazards based on the plurality of data received from the plurality of devices and based on the operation boundary associated with each of the plurality of devices. The one or more hazards may comprise at least one of a conflict between operations, an out-of-bounds location, a low battery status, a low fuel status, or an anomalous operation.

The processor 120 may provide tracking information of each of the plurality of devices and the one or more hazards associated with at least one of the plurality of devices. The tracking information may be provided based on the location information associated with each of the plurality of devices. The processor 120 may provide the tracking information and the one or more hazards to a display unit 170. The display unit 170 may visualize the tracking information of each of the plurality of devices and the one or more hazards associated with at least one of the plurality of devices in real time.

The amplifier 130 may include an instrumentation amplifier such as a MAX4208. The amplifier 130 may be used to amplify the signal received from other devices. The memory 140 may include a volatile and/or non-volatile memory. The memory 140 may store, for example, a command or data related to at least one different constitutional element of the computing device 101. According to various exemplary embodiments, the memory 140 may store a software and/or a program 150. The program 150 may include, for example, a kernel 151, a middleware 153, an Application Programming Interface (API) 155, and/or an application program (or an “application”) 157, or the like, configured for controlling one or more functions of the computing device 101 and/or an external device. At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 130, etc.) used to execute an operation or function implemented in other programs (e.g., the middleware 153, the API 155, or the application program 157). Further, the kernel 151 may provide an interface capable of controlling or managing the system resources by accessing individual constitutional elements of the computing device 101 in the middleware 153, the API 155, or the application program 157.

The middleware 153 may perform, for example, a mediation role so that the API 155 or the application program 157 can communicate with the kernel 151 to exchange data.

Further, the middleware 153 may handle one or more task requests received from the application program 157 according to a priority. For example, the middleware 153 may assign a priority of using the system resources (e.g., the bus 110, the processor 120, or the memory 140) of the computing device 101 to at least one of the application programs 157. For instance, the middleware 153 may process the one or more task requests according to the priority assigned to the at least one of the application programs, and thus may perform scheduling or load balancing on the one or more task requests.

The API 155 may include at least one interface or function (e.g., instruction), for example, for file control, window control, video processing, or character control, as an interface capable of controlling a function provided by the application program 157 in the kernel 151 or the middleware 153.

For example, the input/output interface 160 may play a role of an interface for delivering an instruction or data input from a user or a different external device(s) to the different constitutional elements of the computing device 101. Further, the input/output interface 160 may output an instruction or data received from the different constitutional element(s) of the computing device 101 to the different external device.

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body.

The communication interface 180 may establish, for example, communication between the computing device 101 and an external device (e.g., the UAVs 102a-d, the vehicles 103a-d, the assets 104a-d and/or the server 106). In one example, the communication interface 180 may communicate with the UAVs 102a-d, the vehicles 103a-d, and/or the assets 104a-d through wireless communication. In one example, the communication interface 180 may communicate with the external device (e.g., the UAV 102d, the vehicle 103d, the asset 104d and/or the server 106) by being connected to a network 162 through wireless communication or wired communication.

In another example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication. The near-distance communications may include, for example, at least one of Bluetooth, Long Range Wide Area Network (LoRaWAN), Wireless Fidelity (WiFi), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

The UAVs 102a-d, the vehicles 103a-d, and/or the assets 104a-d may be equipped with a transmitter and/or a receiver. The transmitter and/or the receiver may be a wireless transmit/receive unit. The wireless transmit/receive unit may refer to a device or equipment that can both transmit and receive data wirelessly. The wireless transmit/receive unit may support the cellular communication protocols such as LTE, LTE-A, CDMA, WCDMA, UMTS, WiBro, GSM, and the like. The wireless transmit/receive unit may also support the near-distance communications such as Bluetooth, LoRaWAN, WiFi, NFC, GNSS, and the like. The wireless transmit/receive unit may be an Automatic Dependent Surveillance-Broadcast (ADS-B). For example, the ADS-B may be equipped with the UAVs 102a-d, the vehicles 103a-d, and/or the assets 104a-d, and used for tracking, surveillance, and communication of the UAVs 102a-d, the vehicles 103a-d, and/or the assets 104a-d.

According to one exemplary embodiment, the server 106 may include a group of one or more servers. According to various exemplary embodiments, all or some of the operations executed by the computing device 101 may be executed in a different one or a plurality of devices (e.g., the server 106). According to one exemplary embodiment, if the computing device 101 needs to perform a certain function or service either automatically or based on a request, the computing device 101 may request at least some parts of functions related thereto alternatively or additionally to a different device (e.g., the UAVs 102a-d, the vehicles 103a-d, the assets 104a-d, and the server 106) instead of executing the function or the service autonomously. The different devices (e.g., the UAVs 102a-d, the vehicles 103a-d, the assets 104a-d, and the server 106) may execute the requested function or additional function, and may deliver a result thereof to the computing device 101. The computing device 101 may provide the requested function or service either directly or by additionally processing the received result. For this, for example, a cloud computing, distributed computing, or client-server computing technique may be used.

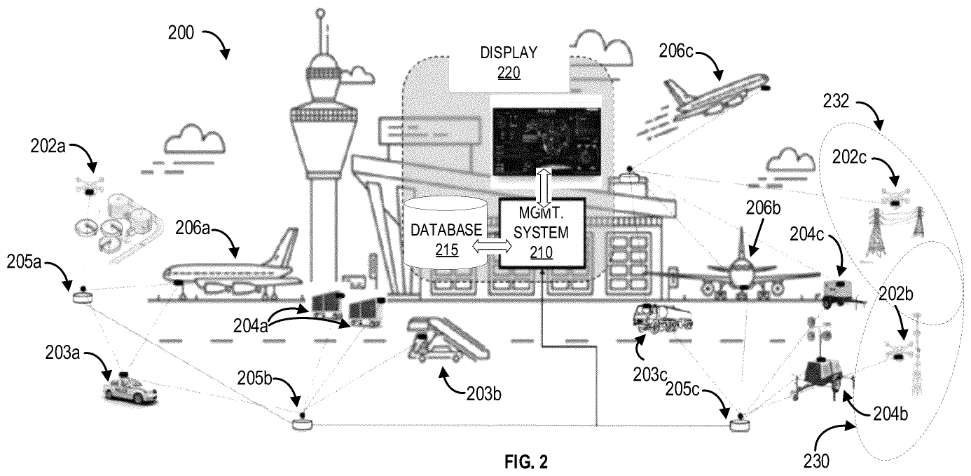

FIG. 2 is an example architecture of a campus 200, which may be used in combination with any of other embodiments described herein. As shown in FIG. 2, the architecture of the campus 200 is described in an airport, but the architecture of the campus 200 may be applied to any campuses described above. The architecture 200 of the campus may comprise a management system 210 (e.g., LAIDAVAMS), a database 215, a display 220 (e.g., the display 170), unmanned aerial vehicles (UAVs) or drones 202a-c, manned aircrafts 206a-c, ground-based vehicles 203a-c, portable assets 204a-c, and fixed assets 205a-c. The ground-based vehicles 203a-c may comprise a law enforcement vehicle (e.g., a police car) 203a, an aircraft passenger stair truck 203b, and a fuel truck 203c. The portable assets 204a-c may comprise portable . . . 204a, portable . . . 204b, and portable . . . 204c. Each of the fixed assets 205a-c may be sensors such as refractive index detection (RID) sensors. The unmanned aerial vehicles (UAVs) or drones 202a-c, the manned aircrafts 206a-c, the ground-based vehicles 203a-c, the portable assets 204a-c, and the fixed assets 205a-c may be equipped with wireless transmit/receive units. The wireless transmit/receive unit may implement various wireless communication technologies. Such wireless communication technologies may include, but are not limited to, Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication technologies may include, for example, a near-distance communication. The near-distance communications may include, for example, at least one of Bluetooth, Wireless Fidelity (WiFi), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wireless communication technologies may further include various Institute of Electrical and Electronics Engineers (IEEE) standards (e.g., 802.11g, 802.11n, 802.11ac, 802.11ax, 802.11be, etc.).

As an example, the wireless communication technologies may further include a Long Range Wide Area Network (LoRaWAN). The LoRaWAN may be a low-power, wide-area network (LPWAN) technology designed for long-range communication with low data rates. The LoRaWAN may enable the UAVs 202a-c, the manned aircrafts 206a-c, the ground-based vehicles 203a-c, the portable assets 204a-c, and the fixed assets 205a-c to provide wireless connectivity over long distances while conserving energy.

As an example, the wireless transmit/receive unit may be an Automatic Dependent Surveillance-Broadcast (ADS-B). The ADS-B may be equipped with the UAVs or drones 202a-c, the manned aircrafts 206a-c, the ground-based vehicles 203a-c, the portable assets 204a-c, and the fixed assets 205a-c. and used for tracking, surveillance, and communication of the UAVs or drones 202a-c, the manned aircrafts 206a-c, the ground-based vehicles 203a-c, the portable assets 204a-c, and the fixed assets 205a-c. The ADS-B may comprise an ADS-B Out Transmitter and an ADS-B In Receiver. The ADS-B Out Transmitter may be the component onboard a device responsible for broadcasting the device's own information, including its GPS-derived position, altitude, speed, heading, and unique identification code (ICAO address). This information may be transmitted periodically to ground stations and other device. The ADS-B In Receiver may allow a device to receive and display the ADS-B broadcast information from nearby devices. The ADS-B transmitter may continuously calculate and broadcast the device's precise position using GPS coordinates. This information may be sent to both the management system 210 and nearby devices such as the UAVs or drones 202a-c, the manned aircrafts 206a-c, the ground-based vehicles 203a-c, the portable assets 204a-c, and the fixed assets 205a-c.

The fixed assets 205a-c may further comprise sensors (e.g., RIDs), ground receivers, gateways to provide complete coverage for the campus (e.g., airport shown in FIG. 2). The ground receiver may refer to a ground-based navigation and landing aid system, for example, used for aircraft during takeoff, landing, and taxiing. One example of ground receiver used at airports may be the Instrument Landing System (ILS), which helps guide aircraft safely to the runway during adverse weather conditions or low visibility. The sensors may be used to provide geofencing capability for the campus. For example, the sensors may create virtual boundaries or “fences” around specific geographic areas. These virtual boundaries may trigger actions when a device or object enters or exits the defined area. For example, RIDs may form an inner ring (e.g., warning area) and an outer ring (e.g., caution area). These rings may be shown on the display 220 associated with the management system 210. Regular air traffic (e.g., manned aircrafts 206a-c) may be shown on the display 220, for example, as a square with the device's identity, speed, and altitude. The regular air traffic may not trigger cautions or warnings when the regular air traffics enter the outer ring or the inner ring defined by the RIDs. The UAVs or drones 202a-c may be shown on the display 220, for example, as triangles. In some cases, the UAVs or drones 202a-c may enter the outer ring to conduct operations. This may trigger a caution in the display 220 with a brief warning sound. If the UAVs or drones 202a-c may continue into the inner ring, this may trigger a waring in the display 220 with continuous alarm sounds.

The database 215 may store data received from the UAVs or drones 202a-c, the manned aircrafts 206a-c, the ground-based vehicles 203a-c, the portable assets 204a-c, and the fixed assets 205a-c. The databased 215 may also store data received from operation managers, tenants, and/or operators. The data received from the operation managers, tenants, and/or operations may be related to operations performed by the UAVs 202a-c, the manned aircrafts 206a-c, the ground-based vehicles 203a-c, the portable assets 204a-c, and the fixed assets 205a-c. The data received from the operation managers, tenants, and/or operations may be related to the operators, the tenant, and/or the operators of the UAVs or drones 202a-c, the manned aircrafts 206a-c, the ground-based vehicles 203a-c, the portable assets 204a-c, and the fixed assets 205a-c. Data stored in the database 215 may comprise location information, system information, and operation information associated with the UAVs or drones 202a-c, the manned aircrafts 206a-c, the ground-based vehicles 203a-c, the portable assets 204a-c, and the fixed assets 205a-c.

The location information may include, but are not limited to, geographical positions such as GPS coordinates, latitude and longitude coordinates, altitude providing the height or elevation above sea level, speed, direction, geofenced area or boundaries associated with operations, addresses, location names, and locations associated with operators. The system information may include, but are not limited to, timestamp records with the date and time when the location data were captured, an identity or a tag for each tracked device, device or sensor information, environmental conditions such as temperature, humidity, and air quality, a battery status, a power status, a fuel status, and data source. The operation information may include, but are not limited to, locations of operations, altitudes of operations, operation schedules, operation statuses, and operator information.

The management system 210 (e.g., LAIDAVAMS) may perform data analysis based on the data fetched/obtained from the database 215. The data analyses may include, but are not limited to, geographic or security hot-spot analysis, anomalous behavior analysis, and operational analysis reporting. In an example, the management system may receive, from the database 215, data associated with locations, systems, and operations of the UAVs 202a-c, the manned aircrafts 206a-c, the ground-based vehicles 203a-c, the portable assets 204a-c, and the fixed assets 205a-c. The data may comprise the location information, the system information, and the operation information described above. The management system 210 may determine operation boundaries associated with the UAVs 202a-c, the ground-based vehicles 203a-c, the portable assets 204a-c, and the fixed assets 205a-c. The operation boundaries may be determined, for example, during an operation registration process and/or an operation authorization process for each of the UAVs 202a-c, the ground-based vehicles 203a-c, the portable assets 204a-c, and the fixed assets 205a-c. The operation boundaries may be manually, semi-automatically, or automatically determined. For example, an airport manager or a facility manager may determine the operation boundary for each of the UAVs 202a-c, the ground-based vehicles 203a-c, the portable assets 204a-c, and the fixed assets 205a-c. Additionally or alternatively, the management system 210 may determine the operation boundaries based on types of operations, schedules of the operations, locations of the operations and/or the like.

The management system 210 may determine one or more hazards for at least one of the UAVs 202a-c, the ground-based vehicles 203a-c, the portable assets 204a-c, and the fixed assets 205a-c. For example, the management system 210 may determine the one or more hazards based on the data and/or the operation boundaries associated with the UAVs 202a-c, the ground-based vehicles 203a-c, the portable assets 204a-c, and the fixed assets 205a-c. The one or more hazards may comprise at least one of a conflict between operations, an out-of-bounds location, a low battery status, a low fuel status, an anomalous operation, or a collision between devices (e.g., the UAVs 202a-c, the manned aircrafts 206a-c, the ground-based vehicles 203a-c, the portable assets 204a-c, and the fixed assets 205a-c).

The conflict between the operations may be determined. For example, the management system 210 may determine a first operation of a UAV 202b. The first operation of the UAV 202b may be determined based on first operation information associated with the UAV 202b. The first operation information may comprise an operation location associated with the UAV 202b, an operation altitude associated with the UAV 202b, and/or an operation schedule associated with the UAV 202b. The operation location associated with the UAV 202b may be a name of the facility/infrastructure (e.g., antenna tower as shown in FIG. 2) and/or the GPS coordinates indicating the location of the first operation. The operation schedule associated with the UAV 202b may be specific time period, durations, start date/time, and/or end date/time. For example, the operation schedule of the first operation may be between 6:00 AM and 8:00 AM on Monday.

The management system 210 may further determine a second operation of a UAV 202c. The second operations of the UAV 202c may be determined based on second operation information associated with the UAV 202c. The second operation information may comprise an operation location associated with the UAV 202c, an operation altitude associated with the UAV 202c, and/or an operation schedule associated with the UAV 202c. The operation location associated with the UAV 202c may be a name of the facility/infrastructure (e.g., power lines as shown in FIG. 2) and/or the GPS coordinates indicating the location of the second operation. The operation schedule associated with the UAV 202c may be specific time period, durations, start date/time, and/or end date/time. For example, the operation schedule of the second operation may be between 7:00 AM and 9:00 AM on Monday.

The management system 210 may determine a first operation boundary 230 associated with the UAV 202b and a second operation boundary 232 associated with the UAV 202b. The first operation boundary 230 may be a part of the first operation information (e.g., the operation location of the first operation information), first location information associated with the UAV 202b, or separate information. The second operation boundary 232 may be a part of the second operation information (e.g., the operation location of the second operation information), second location information associated with the UAV 202c, or separate information.

The management system 210 may determine a possibility of conflict between the first operation and the second operation. For example, the management system 210 may determine the possibility of conflict between the first operation and the second operation based on the first operation information and the second operation information. Specifically, the management system 210 may compare the operation locations associated with the UAV 202b and UAV 202c and/or the operation schedules associated with the UAV 202b and UAV 202c. If the operation locations associated with the UAV 202b and UAV 202c are overlapped and/or the operation schedules associated with the UAV 202b and UAV 202c are overlapped, the management system 210 may determine that there is a possibility of conflict between the first operation and the second operation, for example, via the display 220. Additionally or alternatively, the management system 210 may compare the operation boundaries (e.g., the first operation boundary 230 and the second operation boundary 232) associated with the UAV 202b and UAV 202c and/or the operation schedules associated with the UAV 202b and UAV 202c. As shown in FIG. 2, if the first operation boundary 220 associated with the UAV 202b is overlapped with the second operation boundary 230 associated with UAV 202c, and/or the operation schedules associated with the UAV 202b and UAV 202c are overlapped, the management system 210 may determine that there is a possibility of conflict between the first operation and the second operation. Once the management system 210 determines that there is a possibility of conflict between the first operation and the second operation, the management system 210 cause the first operation associated with the UAV 202b and the second operation associated with the UAV 202c to deconflict with each other.

The out-of-bounds location may be determined. For example, the management system 210 may determine that the UAV 202b is out-of-bounds based on the data (e.g., location information of the UAV 202b) and/or the first boundary 220 associated with the UAV 202b. Specifically, a current GPS location of the UAV 202b may be outside of the first boundary 220. The management system 210 may then determine that the UAV 202b is out-of-bounds and may show that the UVA 202b is out-of-bounds via the display 220.

The low battery status or the low fuel status may be determined. For example, the management system 210 may determine that the battery status of the UAV 202c is low based on the data (e.g., the system information of the data stored in the database 215). The low battery status of the UAV 202c may be shown in the display 220 and a command for the UAV 202c to return to the charging station or to move to a safe location may be sent to the UAV 202c.

The anomalous operation may be determined. For example, the management system 210 may determine that UAV 202b is performing the anomalous operation based on the data (e.g., the operation information of the data stored in the database 215). Specifically, the management system 210 may compare an authorized operation associated with the UAV 202b with a current operation performed by the UAV 202b. The management system 210 may use at least one of the location information associated with the UAV 202b, the operation information associated with the UAV 202b, or the operation boundary (e.g., the first operation boundary 230) associated with the UAV 202b to determine the anomalous operation. For example, although the operation authorized to the UAV 202b is inspection of antenna tower within the boundary 230, the location of the UAV 202b may be indicated near the fuel tank truck 203c. If the UAV 202b stays for longer than a certain time duration (e.g., exceed a threshold or operation time limit), the management system 210 may determine that UAV 202b is performing the anomalous operation. Once the anomalous operation associated with the UAV 202b is determined, the anomalous operation associated with the UAV 202b may be shown using the display 220. A command for the UAV 202b to perform the authored operation or to stop the current operation and move back to a departing location (e.g., the operator's location) associated with the UAV 202b may be sent to the UAV 202b.

In an example, the management system 210 may provide a registration process for the UAVs or drones 202a-c, the ground-based vehicles 203a-c, the portable assets 204a-c, and/or the fixed assets 205a-c. For example, a campus tenant or an operator may decide to use the UAVs or drones 202a-c (or other ground-based vehicles or other fixed/portable assets) for inspections. The campus tenant or the operator may submit a request for drone operations to a campus manager or the management system 210. The request may comprise details of drone operations such as the type of operation, frequency, time of day, location, and the like. The campus manager or the management system 210 may evaluate the request against campus operational regulations to approve the request. The campus manager or the management system 210 may approve the request with a condition of modification if necessary. The campus manager or the management system 210 may register the UAVs or drones 202a-c (or other ground-based vehicles or other fixed/portable assets) in the management system 210.

In another example, an operator of the UAVs or drones 202a-c, the ground-based vehicles 203a-c, the portable assets 204a-c, and/or the fixed assets 205a-c may download an application or use an website to request a registration of the operation to be performed by the UAVs or drones 202a-c, the ground-based vehicles 203a-c, the portable assets 204a-c, and/or the fixed assets 205a-c. The request may include a request for the wireless transmit/receive unit (described above) to be attached to the ground-based vehicles 203a-c, the portable assets 204a-c, and the fixed assets 205a-c. The request may include details of drone/vehicle/asset information and proposed operational information (e.g., location/geocage, altitude, typical schedule for repeated operations, etc.). A facility manager or the management system 210 may approve the operator or the operation associated with the operator. Once the request is approved, the facility manager may send the wireless transmit/receive unit to the operator. The operator may then install the wireless transmit/receive unit to the UAVs or drones 202a-c, the ground-based vehicles 203a-c, the portable assets 204a-c, and/or the fixed assets 205a-c that perform the operation. The operator may then install the wireless transmit/receive unit to the UAVs or drones 202a-c, the ground-based vehicles 203a-c, the portable assets 204a-c, and/or the fixed assets 205a-c that perform the operation. Alternatively or additionally, assuming that the UAVs or drones 202a-c, the ground-based vehicles 203a-c, the portable assets 204a-c, and/or the fixed assets 205a-c are equipped with the wireless transmit/receive units, the management system 210 may approve or register the identities (e.g., International Mobile Equipment Identity (IMEI)) of the wireless transmit/receive units in the management system 210. The facility manager and/or the operator may convene to conduct controlled test to validate the wireless transmit/receive unit is properly working.

In another example, the management system 210 may receive a registration request for an operation associated with a device such as one of the UAVs or drones 202a-c, the ground-based vehicles 203a-c, the portable assets 204a-c, and/or the fixed assets 205a-c. The registration request may comprise device information and/or operation information associated with the device. The device information may comprise a device identity and a type of device. The operation information may comprise an operation location, an operation altitude, and an operation schedule associated with the device. The management system 210 may assess the operation based on the device information and the operation information associated with the device. The management system 210 may also assess the operation based on device information and operation information associated with other devices. For example, the management system 210 may consider the location of the operation and locations of other operations, or the scheduled of the operation and scheduled of other operations. The management system 210 may send, based on the assessment, a registration response. The registration response may indicate that the operation is registered. For example, the registration response may comprise an authorized boundary associated with the operation.

In an example, the management system 210 may receive an operation request to initiate an operation associated with the UAVs or drones 202a-c, the ground-based vehicles 203a-c, the portable assets 204a-c, and/or the fixed assets 205a-c. The operation request may comprise an operation location, an operation schedule, and an operation type associated with the UAVs or drones 202a-c, the ground-based vehicles 203a-c, the portable assets 204a-c, and/or the fixed assets 205a-c. The management system 210 may assess the operation request (e.g., similar to the assessment described above) and send an approval for the operation. The management system 210 may then monitor the operation associated with the UAVs or drones 202a-c, the ground-based vehicles 203a-c, the portable assets 204a-c, and/or the fixed assets 205a-c.

For one-time operations and/or repeatable operations, an operator may use an application to schedule the operations. The operator may provide schedules of the operations, geofencing or geocage information associated with the operations, and/or types of the operations. For drone operations, the operator may coordinate with the Low Altitude Authorization and Notification Capability (LAANC) which provides drone pilots with access to controlled airspace at or below 400 feet. A facility manager may approve the operations. The approval may be automatic for trusted, regular operators such as security, maintenance, etc. The approval process may take no longer than 2 minutes. Once the operator performs the approved operations using the UAVs or drones 202a-c, the ground-based vehicles 203a-c, the portable assets 204a-c, and/or the fixed assets 205a-c, the facility manager may monitor the operations performed by the UAVs or drones 202a-c, the ground-based vehicles 203a-c, the portable assets 204a-c, and/or the fixed assets 205a-c. The facility manager may address one or more anomalous behaviors of the UAVs or drones 202a-c, the ground-based vehicles 203a-c, the portable assets 204a-c, and/or the fixed assets 205a-c. In some cases, the facility manager may coordinate with a law enforcement entity or an airport traffic control (ATC) to address the one or more anomalous behaviors.

An operation report may be generated. For example, the management system 210 may generate an operation report based on operation data associated with the UAVs or drones 202a-c, the ground-based vehicles 203a-c, the portable assets 204a-c, and/or the fixed assets 205a-c. The operation data may include, but are not limited to, a number of operations, duration of operations, a travel distance of operations, a maximum altitude of operations, an average altitude of operations, one or more geographic hot-spots of operations, and a number of geo-fencing non-compliance of operations. In an example, a facility manager may analyze the operation data such as hot-spots, anomalous operations, registered users operations, etc. and may publish the operation report. The management system 210 may generate the operation report on a periodic basis. For example, the operation report may be generated daily, monthly, and/or annually, based on the operation data.

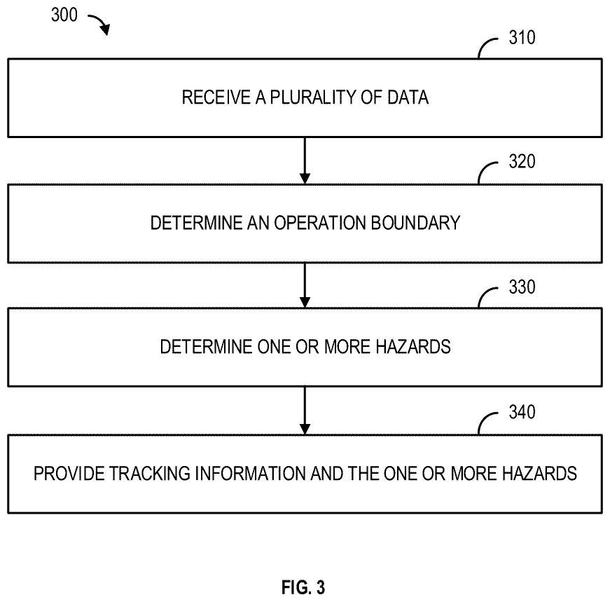

FIG. 3 shows an example method 300 for local area integrated done, aircraft, vehicle, and asset management, which may be used in combination with any of other embodiments described herein. At step 310, a plurality of data may be received. For example, the computing device 101 may receive the plurality of data from a plurality of devices. The plurality of devices may comprise one or more unmanned aerial vehicles (UAVs) (e.g., the UAVs 102a-c), one or more ground vehicles (e.g., the vehicles 103a-c), and one or more assets (e.g., assets 104a-c). The one or more assets may be at least one of a portable asset (e.g., the portable assets 204a-c) or a fixed asset (e.g., the fixed assets 205a-c).

Each of the plurality of data may comprise location information, system information, and operation information associated with each of the plurality of devices. The location information may comprise geographical positions such as GPS coordinates, latitude and longitude coordinates, altitude providing the height or elevation above sea level, speed, direction, geofenced area or boundaries associated with operations, addresses, location names, and/or locations associated with operators. The system information may comprise timestamp records with the date and time when location data were captured, an identity or a tag for each tracked device, device or sensor information, environmental conditions such as temperature, humidity, and air quality, a battery status, a power status, a fuel status, and/or data source. The operation information may comprise locations of operations, altitudes of operations, operation schedules, operation statuses, and/or operator information.

At step 320, an operation boundary may be determined. For example, the computing device 101 may determine the operation boundary associated with each of the plurality of devices. The management system 210 may determine the operation boundary based on a type of operation, a schedule of the operation, a location of the operation and/or the like. Alternatively or additionally, an airport manager or a facility manager may determine the operation boundary for each of the plurality of devices. The operation boundary may be a part of the operation information or separate information.

At step 330, one or more hazards for at least one of the plurality of devices may be determined. For example, the computing device 101 may determine the one or more hazards based on the plurality of data received from the plurality of devices and based on the operation boundary associated with each of the plurality of devices. The one or more hazards may comprise at least one of a conflict between operations, an out-of-bounds location, a low battery status, a low fuel status, or an anomalous operation.

In an example, in order to determine the conflict between the operations, the computing device 101 may determine a first operation associated with a first device of the plurality of devices.

The first operation of the first device may be determined based on first operation information associated with the first device. The first operation information may comprise an operation location associated with the first device, an operation altitude associated with the first device, and/or an operation schedule associated with the first device. The computing device 101 may further determine a second operation associated with a second device of the plurality of devices. The second operations of the second device may be determined based on second operation information associated with the second device. Similar to the first operation information, the second operation information may comprise an operation location associated with the second device, an operation altitude associated with the second device, and/or an operation schedule associated with the second device.

The computing device 101 may determine a first operation boundary associated with the first device and a second operation boundary associated with the second device. The first operation boundary may be a part of the first operation information (e.g., the operation location of the first operation information), first location information associated with the first device, or separate information. The second operation boundary may be a part of the second operation information (e.g., the operation location of the second operation information), second location information associated with the second device, or separate information.

The computing device 101 may determine a possibility of conflict between the first operation and the second operation, for example, based on the first operation information and the second operation information. Specifically, the computing device 101 may compare an operation location associated with the first device with an operation location associated with the second device. The computing device 101 may also compare an operation schedule associated with the first device with an operation schedule associated with the second device. In case that the operation location associated with the UAV 202b overlaps with the operation location associated with the second device, and/or the operation schedule associated with the first device overlaps with the operation schedule associated with the second device, the computing device 101 may determine that there is a possibility of conflict between the first operation and the second operation. Additionally or alternatively, the computing device 101 may compare the an operation boundary associated with the first device with an operation boundary associated with the second device. If the first operation boundary associated with the first device is overlapped with the second operation boundary associated with the second device, and/or the operation schedule associated with the first device is overlapped with the operation schedule associated with the second device, the computing device 101 may determine that there is a possibility of conflict between the first operation and the second operation. Once the computing device 101 determines the possibility of conflict, the computing device 101 may display the possibility of conflict via the display 170. The computing device 101 may also cause the first operation and the second operation not to conflict with each other.

In an example, the computing device 101 may determine that a device of the plurality of devices is out-of-bounds based on the location information of the device and/or the boundary associated with the device. For example, the computing device 101 may recognize that a GPS location of the first device is outside of the boundary. The computing device 101 may then determine that the device is out-of-bounds and may show the out-of-bounds message via the display 170. In another example, the computing device 101 may determine a low battery status of a device of the plurality of devices on the system information associated with the device. Once the low battery status is determined, the computing device 101 may display the low battery status (or a low battery status message) using the display 170. The computing device 101 may command the device to move to a safe location (e.g., a predetermined charging location).

In an example, the computing device 101 may determine that a device of the plurality of devices is performing an anomalous behavior based on operation information associated with the device. Specifically, the computing device 101 may compare an authorized operation associated with the device with a current operation of the device. The computing device 101 may use at least one of location information associated with the device, the operation information associated with the device, or an operation boundary associated with the device, to determine the anomalous behavior. Once the device is determined to perform the anomalous behavior, the computing device 101 may show the anomalous behavior (or an anomalous behavior message) via the display 170. The computing device 101 may command the device to perform the authored operation or stop the current anomalous behavior.

At step 340, tracking information of each of the plurality of devices and the one or more hazards associated with at least one of the plurality of devices may be provided. For example, the computing device 101 may provide (or display) the tracking information of each of the plurality of devices and the one or more hazards associated with at least one of the plurality of devices. The tracking information may be provided based on the location information associated with each of the plurality of devices.

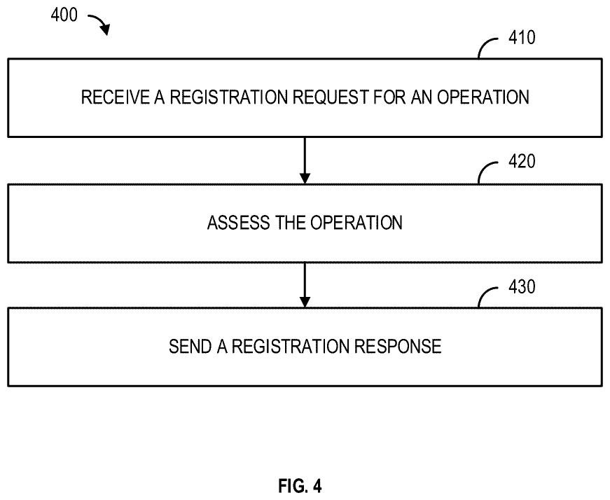

FIG. 4 shows an example registration process 400 for local area integrated done, aircraft, vehicle, and asset management, which may be used in combination with any of other embodiments described herein. At step 410, a registration request for an operation may be received. For example, the computing device 101 may receive the registration request for the operation. The operation may be associated with a device of a plurality of devices. The plurality of devices may comprise one or more unmanned aerial vehicles (UAVs) (e.g., the UAVs 102a-c), one or more ground vehicles (e.g., the vehicles 103a-c), and one or more assets (e.g., assets 104a-c). The one or more assets may be at least one of a portable asset (e.g., the portable assets 204a-c) or a fixed asset (e.g., the fixed assets 205a-c). The registration request may comprise device information associated with the device and operation information associated with the device. The device information may comprise a device identity and a type of device. The operation information may comprise an operation location, an operation altitude, an operation schedule, and operator information. The operator information may further comprise an operator's contact information, the operator's address, the operator's business hours, the operator's emergency contact, the operator's phone number, and the like.

At step 420, the operation may be assessed. For example, the computing device 101 may assess the operation based on the device information associated with the device and the operation information associated with the device. The computing device 101 may further review device information associated with other devices and operation information associated with other devices to assess the requested operation associated with the device. For example, the computing device 101 may compare the location operation associated with the device with other operation locations associated with other devices to determine if there is a location conflict between the operation and other operations. The computing device 101 may compare the operation schedule associated with the device with other operation schedules associated with other devices to determine if there is a time conflict between the operation and other operations.

At step 430, a registration response may be sent. For example, the computing device 101 may send the registration response based on the assessment. The registration response may indicate whether the operation is registered or not. For example, if the computing device 101 determines that there is a conflict (e.g., the location conflict and/or the schedule conflict) between the operation and at least one operation of all other operations, the computing device 101 may send the registration response indicating that the operation is not registered or needs modification. If the computing device 101 determines that there is no conflict between the operation and other operations, the computing device 101 may send the registration response indicating that the operation is registered. In an example, the registration response may include an operation boundary associated with the device.

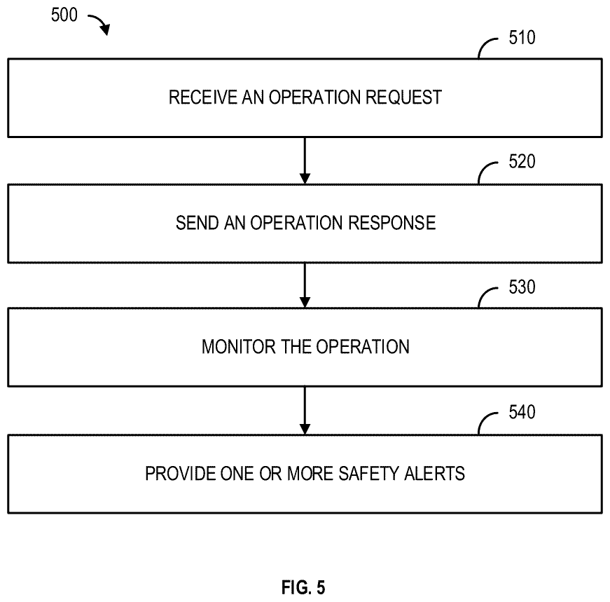

FIG. 5 shows an example operation approval and monitoring process 500 for local area integrated done, aircraft, vehicle, and asset management, which may be used in combination with any of other embodiments described herein. At step 510, an operation request may be received. For example, the computing device 101 may receive the operation request to initiate an operation associated with a device of the plurality of devices. The plurality of devices may comprise one or more unmanned aerial vehicles (UAVs) (e.g., the UAVs 102a-c), one or more ground vehicles (e.g., the vehicles 103a-c), and one or more assets (e.g., assets 104a-c). The one or more assets may be at least one of a portable asset (e.g., the portable assets 204a-c) or a fixed asset (e.g., the fixed assets 205a-c). The operation may be a one-time operation or repeatable operation. The operation request may comprise an operation location associated with the device, an operation schedule associated with the device, and/or an operation type associated with the device. The operation location, the operation schedule and/or the operation type may be provided by an operator associated with the device. For example, the operator may schedule a specific time period (e.g., one day, one month, six month, etc.) using an application or a website.

At step 520, an operation response may be sent. For example, the computing device 101 may send the operation response to the device. The operation response may indicate whether the operation is approved or not. The computing device 101 may determine the operation response based on the operation request. For example, the computing device 101 may assess the operation location, the operation schedule and/or the operation type to determine the approval. Specifically, the computing device 101 may compare the operation location associated with the device with operation locations associated with other devices. Alternatively or additionally, the computing device 101 may compare the operation schedule associated with the device with operation schedules associated with other devices. Alternatively or additionally, the computing device 101 may compare the operation type associated with the device with operation types associated with other devices. The assessment for the operation approval may be the same or similar to the assessment for the registration described in FIG. 4.

The determination for the operation approval may be manually, semi-automatically, or automatically performed. For example, a facility manager may approve the operation after reviewing the operation request. For trusted, regular operations such as a security operation, a regular maintenance operation, and/or the like, the operation may be approved automatically.

At step 530, the operation may be monitored. For example, once the operation is approved, the computing device 101 may monitor the operation associated with the device. Specifically, the computing device 101 may monitor a location of the device, operation duration of the device, a system status (e.g., battery status) of the device, a trajectory of the device, and an anomalous behavior of the device, and/or the like. For example, the computing device 101 may determine that the battery status of the device is low based on system information of the device. The low battery status of the device may be shown in the display 170. The computing device 101 may determine that the device is likely to collide with other devices based on the trajectories of the device and other devices. The computing device 101 may determine that the device is performing the anomalous behavior based on operation information associated with the device.

At step 540, one or more safety warnings may be provided. For example, the computing device 101 may provide the one or more safety warnings via the display 170. The one or more safety warnings may be one or more message indicating the type of warning, one or more symbols or signs indicating the type of warning, one or more alarms, and/or the like. The one or more alarm may be brief warning sounds and/or continuous alarm sounds. The computing device 101 may send a command to the device to mitigate the safety warning events. For example, if the safety warning is the low battery status, the computing device 101 may command the device to return to a safe location or a charging location. If the safety warning is the anomalous behavior, the computing device 101 may command the device to stop the current operation of the device and move to a safe location for further inspection of the device. In an example, when a safety warning for the device is displayed, the computing device 101 may provide an operator's current location associated with the device. The computing device 101 may determine the current operator's location based on the operation information stored in a database (e.g., the database 215).

In an embodiment, an operation report may be generated. For example, the computing device 101 may generate an operation report based on operation data associated with the plurality of devices. The operation data associated with the plurality of devices may include, but are not limited to, a number of operations, duration of operations, a travel distance of operations, a maximum altitude of operations, an average altitude of operations, one or more geographic hot-spots of operations, and a number of geo-fencing non-compliance of operations. The operation report may be generated daily, monthly, and/or annually, based on the operation data. In an example, a facility manager may analyze the operation data and may publish the operation report.

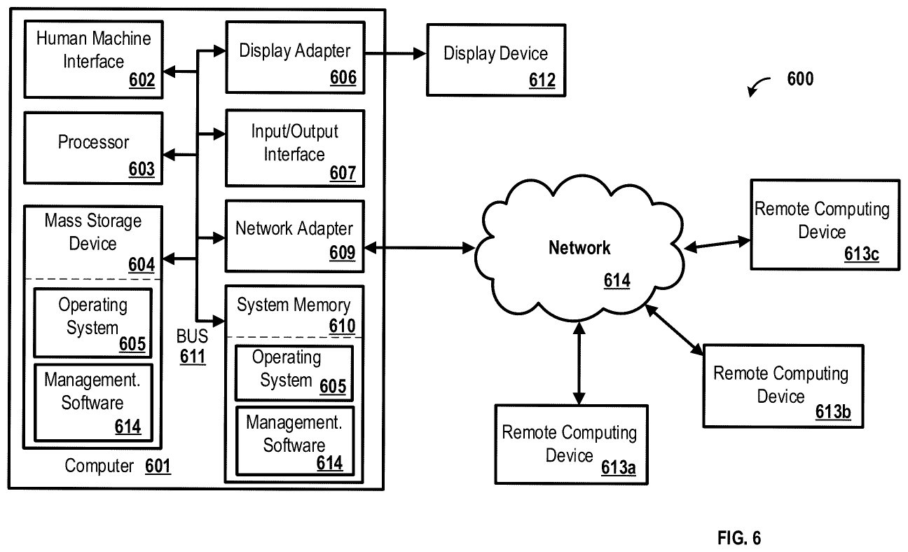

In an exemplary aspect, the methods, apparatuses, and systems can be implemented on a computer 601 as illustrated in FIG. 6 and described below. By way of example, the computing device 101 of FIG. 1 can be a computer 601 as illustrated in FIG. 6. Similarly, the methods, apparatuses, and systems disclosed can utilize one or more computers to perform one or more functions in one or more locations. For example, the computer 601 may perform or implement the methods or processes described in FIGS. 3-5. FIG. 6 is a block diagram illustrating an exemplary operating environment 600 for performing the disclosed methods. This exemplary operating environment 600 is only an example of an operating environment and is not intended to suggest any limitation as to the scope of use or functionality of operating environment architecture. Neither should the operating environment 600 be interpreted as having any dependency or requirement relating to any one or combination of components illustrated in the exemplary operating environment 600.

The present methods, apparatuses, and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems, apparatuses, and methods disclosed herein can be implemented via a general-purpose computing device in the form of a computer 601. The computer 601 can comprise one or more components, such as one or more processors 603, a system memory 610, and a bus 611 that couples various components of the computer 601 comprising the one or more processors 603 to the system memory 610. The system can utilize parallel computing.

The bus 611 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 611, and all buses specified in this description can also be implemented over a wired or wireless network connection and one or more of the components of the computer 601, such as the one or more processors 603, a mass storage device 604, an operating system 605, a network adapter 608, the system memory 610, an Input/Output Interface 607, a display adapter 606, a display device 612, and a human machine interface 602, can be contained within one or more remote computing devices 613a-c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 610 can comprise computer readable media in the form of volatile memory, such as random access memory (RAM), and/or non-volatile memory, such as read only memory (ROM). The system memory 610 typically can comprise data such as the operating system 605 that is accessible to and/or is operated on by the one or more processors 603.

In an embodiment, the computer 601 can also comprise other removable/non-removable, volatile/non-volatile computer storage media. The mass storage device 604 can provide non-volatile storage of computer code, computer readable instructions, data structures, program modules, and other data for the computer 601. For example, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, such as, by way of example, the operating system 605. The operating system 605 can comprise elements of the programming and be stored on the mass storage device 604. Examples of such databases comprise, DB2®, Microsoft® Access, Microsoft® SQL Server, Oracle®, mySQL, PostgreSQL, and the like. The databases can be centralized or distributed across multiple locations within the network 614. For example, the mass storage device 604 or the system memory 610 may store management software 614 for local area integrated done, aircraft, vehicle, and asset management. The management software 614 may perform methods or processes described in FIGS. 2-5.

In an embodiment, the user can enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like

These and other input devices can be connected to the one or more processors 603 via the human machine interface 602 that is coupled to the bus 611, but can be connected by other interface and bus structures, such as a parallel port, game port, an IEEE 1394 Port (also known as a Firewire port), a serial port, a network adapter 609, and/or a universal serial bus (USB).

In an embodiment, the display device 612 can also be connected to the bus 611 via an interface, such as the display adapter 606. It is contemplated that the computer 601 can have more than one display adapter 606 and the computer 601 can have more than one display device 612. For example, the display device 612 can be a monitor, an LCD (Liquid Crystal Display), light emitting diode (LED) display, television, smart lens, smart glass, and/or a projector. The display 612 may visualize tracking information of the UAVs or drones 202a-c, the manned aircrafts 206a-c, the ground-based vehicles 203a-c, the portable assets 204a-c, and the fixed assets 205a-c. The display 612 may also visualize one or more safety alerts associated with operations performed by the UAVs or drones 202a-c, the manned aircrafts 206a-c, the ground-based vehicles 203a-c, the portable assets 204a-c, and the fixed assets 205a-c. In addition to the display device 612, other output peripheral devices can comprise components such as speakers (not shown) and a printer (not shown) which can be connected to the computer 601 via an Input/Output Interface 607. Any step and/or result of the methods can be output in any form to an output device. Such output can be any form of visual representation, comprising, but not limited to, textual, graphical, animation, audio, tactile, and the like. The display device 612 and the computer 601 can be part of one device, or separate devices.

The computer 601 can operate in a networked environment using logical connections to one or more remote computing devices 613a-c. By way of example, a remote computing device 613a-c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The remote computing device 613a-c may be the UAVs 202a-c, the manned aircrafts 206a-c, the ground-based vehicles 203a-c, the portable assets 204a-c, and/or the fixed assets 205a-c. Logical connections between the computer 601 and a remote computing device 613a-c can be made via a network 614, such as a Long Range Wide Area Network (LoRaWAN), a local area network (LAN) and/or a general wide area network (WAN). Such network connections can be through the network adapter 609. The network adapter 609 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components can reside at various times in different storage components of the computing device 601, and are executed by the one or more processors 603 of the computer 601. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, from a plurality of devices, a plurality of data, wherein each of the plurality of data comprises location information, system information, and operation information associated with each of the plurality of devices;
determining an operation boundary associated with the each of the plurality of devices;
determining, based on the plurality of data and based on the operation boundary associated with the each of the plurality of devices, one or more hazards for at least one of the plurality of devices; and
providing, based on the location information associated with the each of the plurality of devices, tracking information of the each of the plurality of devices and the one or more of hazards associated with the at least one of the plurality of devices.

2. The method of claim 1, wherein the plurality of devices comprise one or more unmanned aerial vehicles (UAVs), one or more ground vehicles, and one or more assets.

3. The method of claim 2, wherein the one or more assets are at least one of a portable asset or a fixed asset.

4. The method of claim 1, wherein the operation information comprises an operation location, an operation altitude, and an operation schedule, and wherein the system information comprises a battery status or a fuel status.

5. The method of claim 1, wherein the one or more of hazards comprise at least one of a conflict, an out-of-bounds location, a low battery status, a low fuel status, or an anomalous operation.

6. The method of claim 5, further comprising:
determining, based on first operation information associated with a first device of the plurality of devices, a first operation, wherein the first operation information comprises an operation location of the first device, an operation altitude of the first device, and an operation schedule of the first device;
determining, based on second operation information associated with a second device of the plurality of devices, a second operation, wherein the second operation information comprises an operation location of the second device, an operation altitude of the second device, and an operation schedule of the second device; and
determining, based on the first operation information and the second operation information, the conflict between the first operation associated with the first device and the second operation associated with the second device.

7. The method of claim 6, further comprising:
causing, based on the conflict, the first operation associated with the first device and the second operation associated with the second device to deconflict with each other.

8. The method of claim 5, further comprising:
determining, based on a location associated with a device of the plurality of devices and based on an operation boundary associated with the device, that the device is in the out-of-bounds location.

9. The method of claim 5, further comprising:
determining, based on system information of a device of the plurality of devices, the low battery status or the low fuel status.

10. The method of claim 5, further comprising:
determining, based on an authorized operation associated with a device of the plurality of devices and based on a current operation associated with the device, that the device is in the anomalous operation.

11. The method of claim 1, further comprising:
receiving a registration request for an operation associated with a device of the plurality of devices, wherein the registration request comprises device information and operation information associated with the device, wherein the device information comprises a device identity and a type of device, and the operation information comprises an operation location, an operation altitude, and an operation schedule;
assessing, based on the device information and the operation information associated with the device and based on device information and operation information associated with other devices, the operation; and
sending, based on the assessment, a registration response indicative of the operation being registered, wherein the registration response comprises an authorized operation boundary associated with the device.

12. The method of claim 1, further comprising:
receiving an operation request to initiate an operation associated with a device of the plurality of devices, wherein the operation request comprises an operation location, an operation schedule, and an operation type;
sending, based on the operation request, an operation response indicative of an approval for the operation associated with the device; and
monitoring the operation associated with the device.

13. The method of claim 1, further comprising:
generating, based on operation data associated with the plurality of devices, an operation report, wherein the operation data associated with the plurality of devices comprise a number of operations, duration of operations, a travel distance of operations, a maximum altitude of operations, an average altitude of operations, one or more geographic hot-spots of operations, and a number of geo-fencing non-compliance of operations.

14. The method of claim 1, further comprising:
providing one or more safety alerts for the at least one of the plurality of devices associated with the one or more hazards; and
providing one or more operator locations of the at least one of the plurality of devices associated with the one or more hazards.

15. An apparatus comprising:
one or more processors; and
a memory storing processor-executable instructions that, when executed by the one or more processors, cause the apparatus to:
receive, from a plurality of devices, a plurality of data, wherein each of the plurality of data comprises location information, system information, and operation information associated with each of the plurality of devices;
determine an operation boundary associated with the each of the plurality of devices;
determine, based on the plurality of data and based on the operation boundary associated with the each of the plurality of devices, one or more hazards for at least one of the plurality of devices; and
provide, based on the location information associated with the each of the plurality of devices, tracking information of the each of the plurality of devices and the one or more hazards associated with the at least one of the plurality of devices.

16. The apparatus of claim 15, wherein the plurality of devices comprise one or more unmanned aerial vehicles (UAVs), one or more ground vehicles, and one or more assets.

17. The apparatus of claim 15, wherein the one or more hazards comprise at least one of a conflict, an out-of-bounds location, a low battery status, a low fuel status, or an anomalous operation.

18. A system comprising:
a plurality of devices comprising one or more unmanned aerial vehicles (UAVs), one or more ground vehicles, and one or more assets, the plurality of devices configured to:
determine a plurality of data, wherein each of the plurality of data comprises location information, system information, and operation information associated with each of the plurality of devices; and
a computing device configured to:
receive, from the plurality of devices, the plurality of data;
determine an operation boundary associated with the each of the plurality of devices;
determine, based on the plurality of data and based on the operation boundary associated with the each of the plurality of devices, one or more hazards for at least one of the plurality of devices; and
provide, based on the location information associated with the each of the plurality of devices, tracking information of the each of the plurality of devices and the one or more hazards associated with the at least one of the plurality of devices.

19. The system of claim 18, wherein the operation information comprises an operation location, an operation altitude, and an operation schedule, and wherein the system information comprises a battery status or a fuel status.

20. The system of claim 18, wherein the one or more hazards comprise at least one of a conflict, an out-of-bounds location, a low battery status, a low fuel status, or an anomalous operation.
